(19) United States
(12) Patent Application Publication
(10) Pub. No.: US 2012/0169251 A1
(43) Pub. Date: Jul. 5, 2012

(54) LIGHT EMITTING DIODE LAMP AND METHOD FOR FABRICATING THE SAME

(75) Inventors: Kou-Rueh Lai, Hsinchu City (TW); Kung-Chi Ho, Hsinchu County (TW)

(73) Assignee: NOVALITE OPTRONICS CORP., Hsinchu City (TW)

(21) Appl. No.: 13/110,002

(22) Filed: May 18, 2011

Related U.S. Application Data
(60) Provisional application No. 61/428,873, filed on Dec. 31, 2010.

(30) Foreign Application Priority Data
Feb. 25, 2011 (TW) 100106503

(51) Int. Cl. H05B 37/02; H01K 1/30; H01J 9/24

(52) U.S. Cl. 315/294; 445/23; 313/110

(57) ABSTRACT

A structure of a light emitting diode (LED) lamp and a method for fabricating the same are provided. In the structure of the LED lamp, LEDs are designed to approach an inner surface of a lampshade more closely, so that the LED lamp has high brightness and high light-use efficiency. The method for fabricating the LED lamp includes the following steps. First, a holder is provided and at least one flexible LED light bar is assembled on the holder. The flexible LED light bar is then forced to approach the holder, and the flexible LED light bar as well as the holder are inserted into the lampshade. After the flexible LED light bar and the holder are inserted into the lampshade, the flexible LED light bar is bent outward to approach the inner surface of the lampshade. After that, the holder and the lampshade are assembled on a socket.

### CROSS-REFERENCE TO RELATED APPLICATION

This application claims the priority benefits of U.S. provisional application Ser. No. 61/428,873, filed on Dec. 31, 2010 and Taiwan application serial no. 100106503, filed on Feb. 25, 2011. The entirety of each of the above-mentioned patent applications is hereby incorporated by reference herein and made a part of this specification.

### BACKGROUND OF THE INVENTION

1. Technical Field

The disclosure is related to a lamp and a method for fabricating the same, and in particular to a light emitting diode (LED) lamp and a method for fabricating the same.

2. Background

Since Thomas Edison invented the incandescent lamp, electric lighting has been widely used in the world. Nowadays, high-brightness and durable lighting devices such as the fluorescent lamp have also been developed. Compared with the incandescent lamp, the fluorescent lamp has advantages such as high efficiency and a low operating temperature. However, heavy metals (mercury) are included in the fluorescent lamp, causing damage to the environment when disposed of.

As lighting technology advances, LED light bars, a type of light source that is more energy-efficient and environment-friendly, have been developed. LEDs in LED light bars utilize recombination of electrons and holes in P-N junctions to generate light. Compared with the incandescent lamp, LED light bars have advantages such as lower power consumption and long life spans. Moreover, LED light bars do not require mercury and are more environment-friendly.

In order to promote LED light bars as a light source for everyday use (such as indoor lighting equipment or outdoor lighting equipment), sockets of LED lamps need to be designed as the same as or compatible with sockets of current light bulbs, so that LED lamps may be directly installed in current lamp bases, thereby increasing public willingness to use LED lamps. However, current LED lamps have problems such as having less-than-expected light emitting uniformity and low light-use efficiency.

FIG. 1 is a schematic diagram showing a conventional LED lamp. Please refer to FIG. 1. A conventional technology of an LED lamp is as follows. An LED element is designed to be fixed near a same surface of a lamp socket. Although the lamp has a light focusing effect, a light emitting angle by the conventional technology is only (less than) 180 degrees. When used for indoor lighting, it cannot replace a incandescent light bulb. Moreover, the conventional technology also uses weighty metal materials, such as aluminum. This not only increases the amount of resources consumed from the Earth, thus not being in line with the goal of energy and carbon emission reduction, but also increases the risk of massive lamps falling and hurting people. FIG. 2 is a schematic diagram showing another conventional LED lamp. Please refer to FIG. 2, the conventional technology of the other LED provides a lamp with a 360-degree light emitting angle. However, in the convention technology, a hard substrate is used to fix the LED at a central position of the lamp, and the LED is limited by the dimensions of the socket of the lamp, so that the LED is away from the lampshade, has a low light emitting efficiency, and has inferior applicability.

### SUMMARY OF THE INVENTION

In light of the above, the disclosure provides a structure and method for fabricating an LED lamp. The LED lamp fabricated according to this method has greater light emitting uniformity and higher light-use efficiency.

The disclosure provides an LED lamp which has superb light emitting uniformity and high brightness.

The disclosure provides a method for fabricating an LED lamp which includes the following steps. A holder is provided. At least one flexible LED light bar is provided and assembled on the holder. The flexible LED light bar is forced to approach the holder, and the flexible LED light bar and the holder are inserted into the lampshade. After the flexible LED light bar and the holder are inserted into the lampshade, the flexible LED light bar is bent outward to approach an inner surface of the lampshade. The holder and the lampshade are assembled on the socket.

The disclosure provides a structure and method for fabricating an LED lamp which includes the following steps. First, a holder is provided, and at least one flexible LED light bar is assembled on the holder. Next, the flexible LED light bar is forced to approach the holder, and the flexible LED light bar and the holder are inserted into the lampshade. After the flexible LED light bar and the holder are inserted into the lampshade, the flexible LED light bar is bent outward to approach the inner surface of the lampshade. Afterwards, the holder and the lampshade are assembled on the socket.

According to an embodiment of the disclosure, the holder includes a pillar and a base. The pillar includes at least one upper fixing part and at least one lower fixing part. The base is connected to the pillar, wherein the upper fixing part of the pillar and the lower fixing part of the pillar respectively pass through a first assembly hole and a second assembly hole of the flexible LED light bar, so that the flexible LED light bar is assembled on the holder.

According to an embodiment of the disclosure, a method for inserting the flexible LED light bar and the holder into the lampshade includes: pushing the flexible LED light bar and the holder into the lampshade, during the process of pushing the flexible LED light bar into the lampshade, the flexible LED light bar is pressured by the lampshade to approach the inner surface of the lampshade, and after the flexible LED light bar is completely pushed into the lampshade, the flexible LED light bar is no longer pressured by the lampshade and recovers to its original state.

According to an embodiment of the disclosure, the upper fixing part of the pillar is located at a top of the pillar, and the lower fixing part of the pillar is located at a sidewall of the pillar.

According to an embodiment of the disclosure, an angle θ is included between an extension direction of the upper fixing part of the pillar and an extension direction of the lower fixing part of the pillar, wherein 90°≦θ≧180°.

According to an embodiment of the disclosure, a shape of the first assembly hole and the second assembly hole of the flexible LED light bar comprises: a circle, a rectangle, or another shape with a necking portion.

According to an embodiment of the disclosure, the holder includes a pillar, a base, and a confinement element. The pillar includes at least one upper fixing part which passes through the first assembly hole of the flexible LED light bar. The base is connected to the pillar. The confinement element encircles the pillar and binds the flexible LED light bar on the pillar.

According to an embodiment of the disclosure, the method for forcing the flexible LED light bar to approach the holder includes: changing the relative positions of the flexible LED light bar and the base, so as to move and force the flexible LED light bar to approach the pillar of the holder.

According to an embodiment of the disclosure, a method for inserting the flexible LED light bar and the holder into the lampshade includes: using the confinement element to move the flexible LED light bar after the flexible LED light bar and the holder are inserted into the lampshade, so that the flexible LED light bar recovers to its original state.

According to an embodiment of the disclosure, the LED lamp may further include a driving current control circuit. The driving current control circuit is disposed in the holder and is electrically connected to the flexible LED light bar.

According to an embodiment of the disclosure, the holder includes a through hole which is passed through by a wire, and the wire is electrically connected to the flexible LED light bar and the driving current control circuit.

According to an embodiment of the disclosure, the inner surface of the socket has a first thread, an outer surface of the holder has a second thread, and the holder is screwed into the socket through cooperation of the first thread and the second thread.

In summary, in the method for fabricating the LED lamp according to the disclosure, by first assembling the flexible LED light bar on the holder and then inserting the flexible LED light bar and the holder into the lampshade, the flexible LED light bar is closer to the inner surface of the lampshade and is bent along the inner surface. Therefore, the LED lamp fabricated according to the fabricating method of the disclosure has higher light-use efficiency and greater light emitting uniformity.

In order to make the aforementioned and other objects, features and advantages of the disclosure comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 are each a schematic diagram showing a conventional LED lamp.

FIG. 3 is a schematic fabrication flowchart of an LED lamp according to the first embodiment of the disclosure.

FIGS. 4A to 4F are schematic diagrams showing a fabrication process of the LED lamp according to the first embodiment of the disclosure.

FIG. 5 is a schematic exploded diagram of the LED lamp according to the first embodiment of the disclosure.

FIGS. 6A to 6E are schematic diagrams showing a fabrication process of an LED lamp according to the second embodiment of the disclosure.

FIGS. 7A to 7G are schematic diagrams showing a fabrication process of an LED lamp according to the third embodiment of the disclosure.

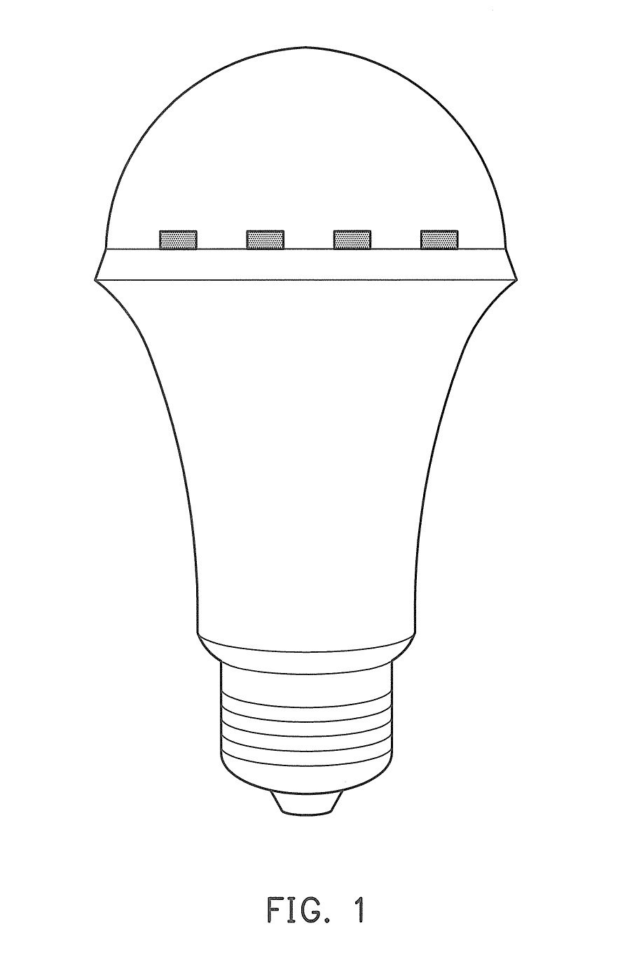

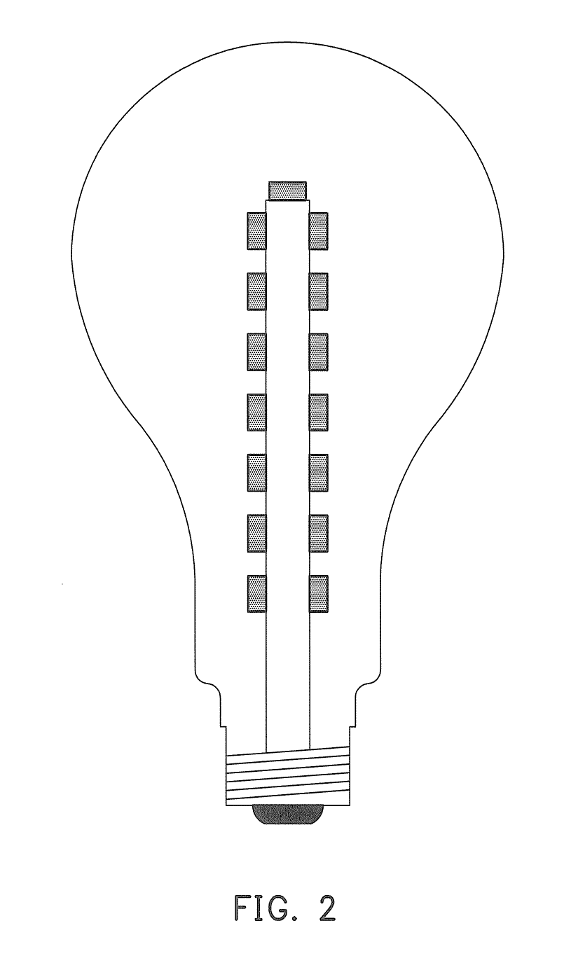

### DETAILED DESCRIPTION OF DISCLOSED EMBODIMENTS

### First Embodiment

### [Method for Fabricating LED Lamp]

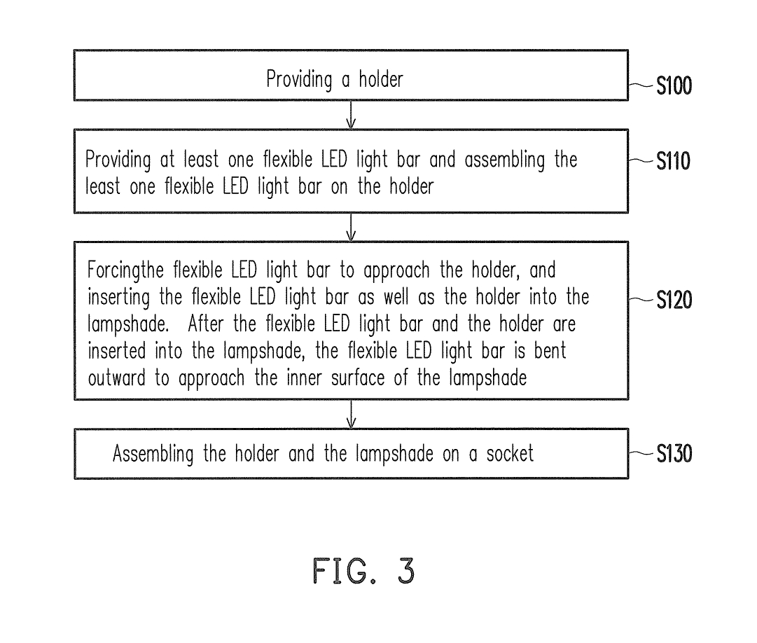

FIG. 3 is a schematic fabrication flowchart of an LED lamp according to the first embodiment of the disclosure. Please refer to FIG. 3. A method for fabricating an LED lamp according to the present embodiment includes: providing a holder (step S100); providing at least one flexible LED light bar, and assembling the LED light bar on the holder (step S110); forcing the flexible LED light bar to approach the holder, and inserting the flexible LED light bar and the holder into the lampshade; after the flexible LED light bar and the holder are inserted into the lampshade, the flexible LED light bar is bent outward to approach an inner surface of the lampshade (step S120); and assembling the holder and the lampshade on a socket (S130). It should be noted that a sequence in which the above steps are performed may be adequately changed. For example, after sequentially performing step S100 and step S110, step S130 may be performed before step S120. Moreover, after performing step S100, step S130 may be performed first, and step S110 and step S120 may be sequentially performed.

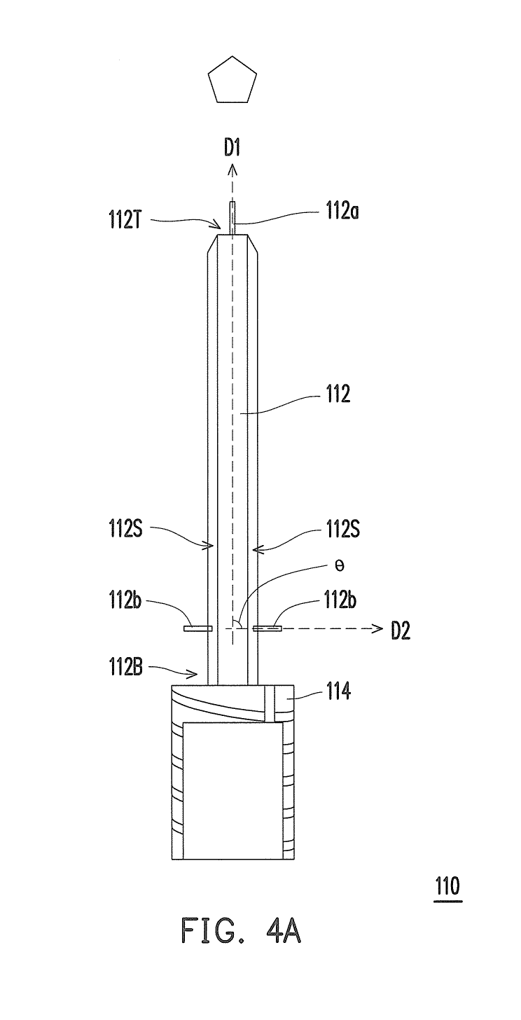

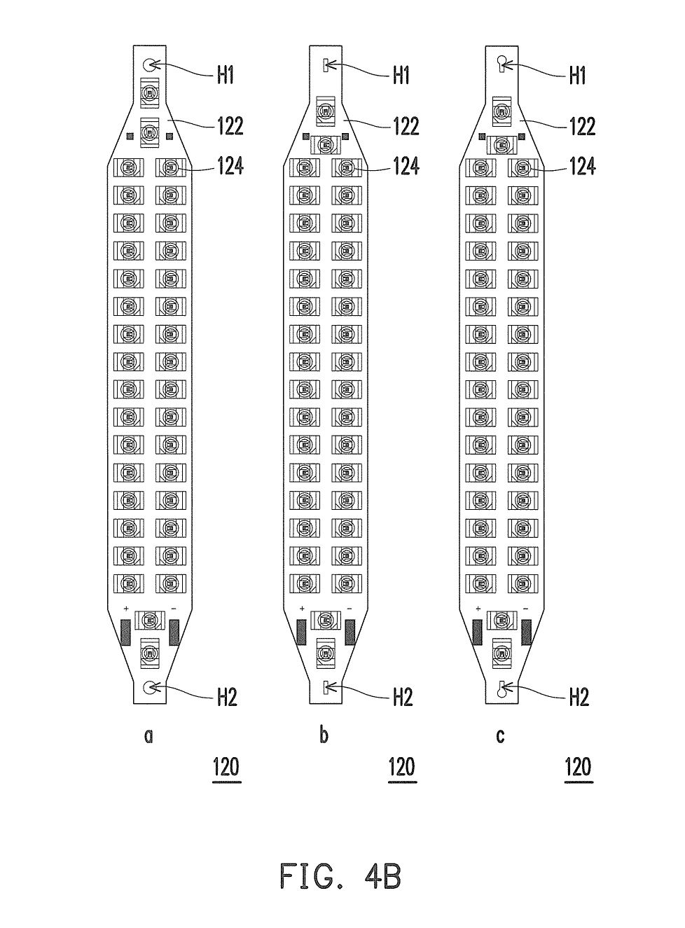

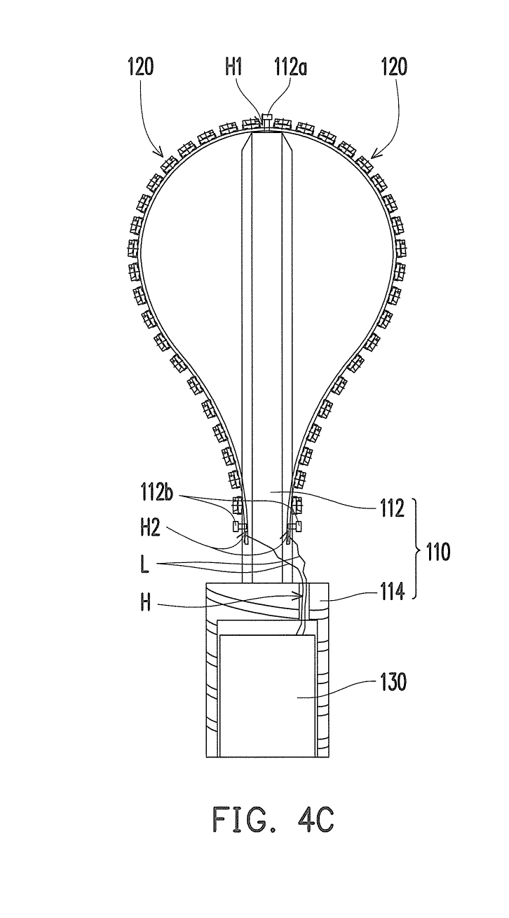

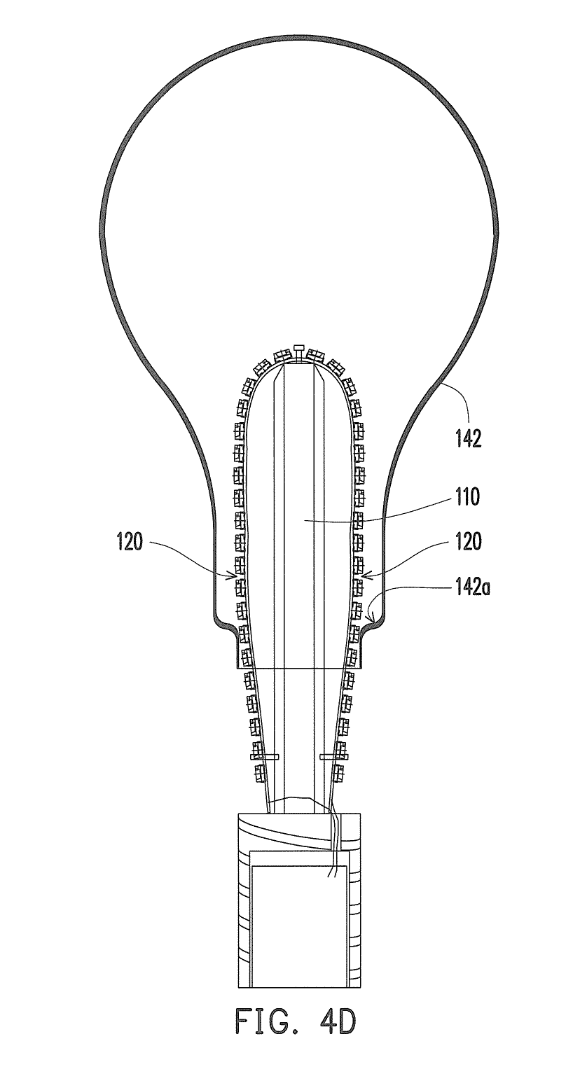

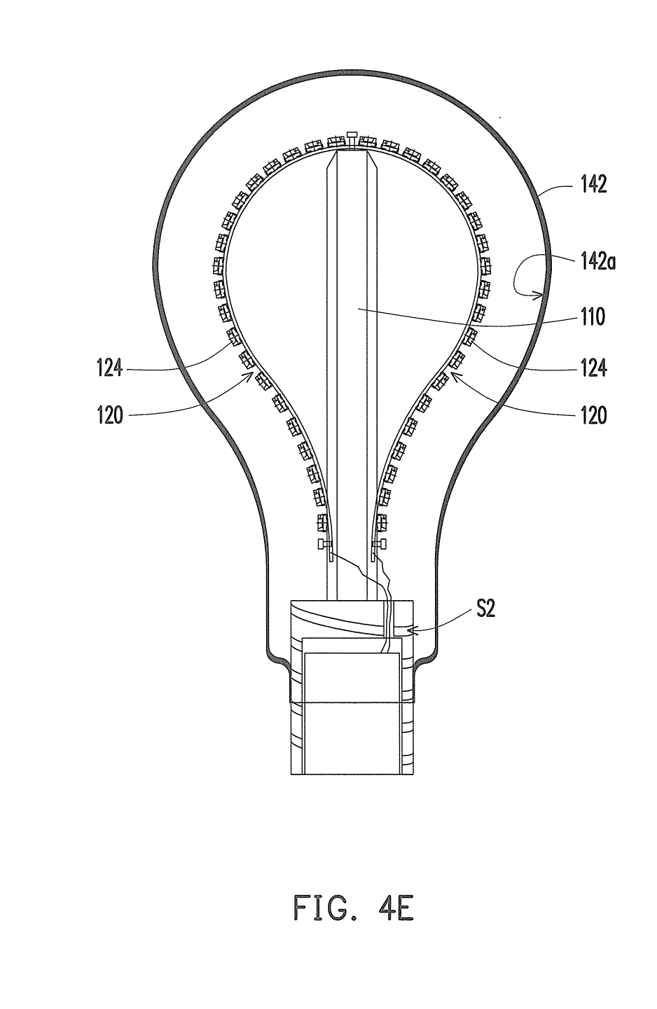

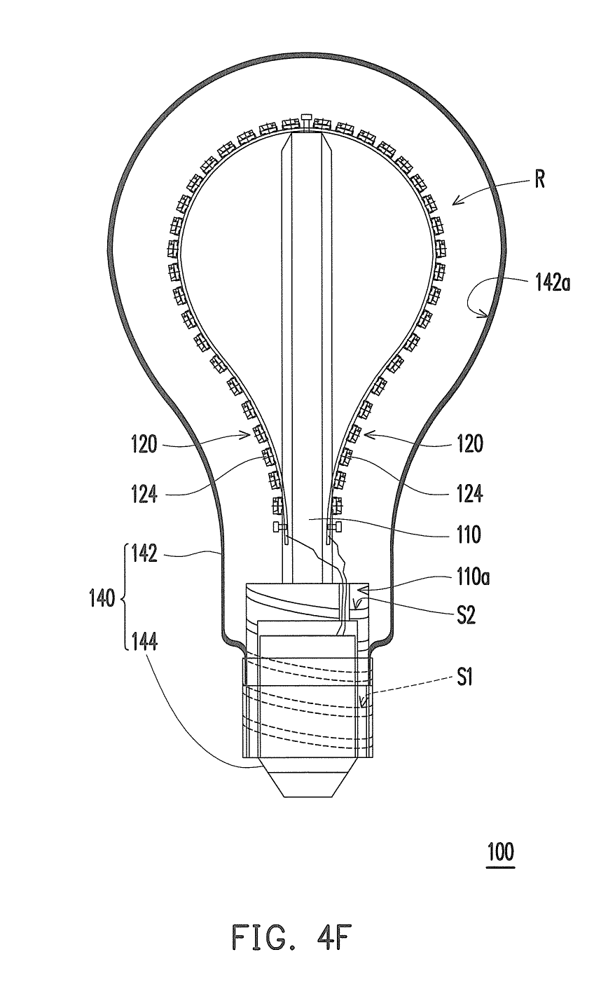

The following uses FIGS. 4A to 4F to describe in detail the method for fabricating the LED lamp.

Please refer to FIG. 4A. First, a holder 110 is provided. The holder 110 includes a pillar 112 and a base 114 connected to the pillar 112. In detail, the pillar 112 according the present embodiment includes at least one upper fixing part 112a and at least one lower fixing part 112b, wherein the upper fixing part 112a of the pillar 112 is located at a top 112T of the pillar 112, and the lower fixing part 112b of the pillar 112 is located at a sidewall 112S of the pillar 112. For example, the pillar 112 is a regular pentagonal pillar. However, the disclosure is not limited to this configuration. According to another embodiment, the pillar 112 may also be a circular pillar, a pillar of another polygon, or a pillar which has a cross-section of another shape. The pillar 112 according the present embodiment may only have one upper fixing part 112a and five lower fixing parts 112b (only two are shown in FIG. 4A), wherein the upper fixing part 112a is located at the top 112T of the pillar 112, and the five lower fixing parts 112b are respectively located at the five sidewalls 112S of the pillar 112 and are near a bottom 112B of the pillar 112. It should be noted that a number of the lower fixing parts 112b is related to the shape of the pillar 112 and a number of the LED light bars 120 (shown in FIG. 4B) to be fixed. The present embodiment does not limit the shape and number of the lower fixing parts 112b. Additionally, according to another embodiment, an angle θ is included between an extension direction D1 of the upper fixing part 112a of the pillar 112 and an extension direction D2 of the lower fixing part 112b of the pillar 112, wherein 90°≦θ≦180°.

Please refer to FIG. 4B. Next, at least one flexible LED light bar 120 is provided. According to the present embodiment, a suitable number (such as five) of flexible LED light bars 120 are provided, wherein each of the flexible LED light bars 120 includes a first assembly hole H1 and a second assembly hole H2 respectively located at two ends thereof. The present embodiment does not limit a number of the flexible LED light bars 120, and one or ordinary skill in the art is able to change the number and specification of the flexible LED light bars 120 according to design requirements. In detail, each of the flexible LED light bars 120 according to the present embodiment includes a flexible circuit substrate 122 and a plurality of LEDs 124 electrically connected to a flexible circuit substrate 122. The flexible circuit substrate 122 according to the present embodiment may be a plastic substrate or a substrate of another suitable material, and the LEDs 124 are, for example, disposed on a surface of the flexible circuit substrate 122. According to the present embodiment, a shape of the first assembly hole H1 and the second assembly hole H2 is a circle (as shown by part a of FIG. 4B), a rectangle (as shown by part b of FIG. 4B), or a shape with a necking portion (as shown by part c of FIG. 4B).

Please refer to FIG. 4C. Next, the flexible LED light bars 120 are assembled on the holder 110. According to the present embodiment, a driving current control circuit 130 is, for example, disposed in the holder 110, and the driving current control circuit 130 is electrically connected to the flexible LED light bars 120. Moreover, according to the present embodiment, the base 114 of the holder 110 has a through hole H which may be passed through by a wire L, and the wire L is electrically connected to the flexible LED light bars 120 and the driving current control circuit 130. The driving current control circuit 130 provides a stable current to the flexible LED light bars 120, so that the LED lamp according to the present embodiment has better optical characteristics and a longer life span. The driving current control circuit according to the present embodiment may be fabricated in the circuit board or be realized in chip form. According to the present embodiment, the upper fixing part 112a of the pillar 112 and the lower fixing parts 112b of the pillar 112 respectively pass through the first assembly hole H1 and the second assembly hole H2 of each of the flexible LED light bars 120, so that each of the flexible LED light bars 120 is assembled on the holder 110.

Please refer to FIGS. 4D and 4E sequentially. Next, the flexible LED light bar 120 is forced to approach the holder 110 (shown in FIG. 4D), and the flexible LED light bars 120 and the holder 110 are inserted into the lampshade 142. After the flexible LED light bars 120 and the holder 110 are inserted into the lampshade 142, the flexible LED light bars 120 are bent outward to approach an inner surface 142a (shown in FIG. 4E) of the lampshade 142. In detail, according to the present embodiment, a method for inserting the flexible LED light bars 120 and the holder 110 into the lampshade 142 is, for example, pushing the flexible LED light bars 120 and the holder 110 into the lampshade 142. During the process of pushing the flexible LED light bars 120 into the lampshade 142, the flexible LED light bars 120 are pressured by the lampshade 142 to approach the inner surface 142a (shown in FIG. 4D) of the lampshade 142. After the flexible LED light bars 120 are completely pushed into the lampshade 142, the flexible LED light bars 120 are no longer pressured by the lampshade 142 and recover to their original state (as shown in FIG. 4E). It should be noted that after the flexible LED light bars 120 are completely pushed into the lampshade 142, shortest distances between each of the LEDs 124 and the inner surface 142a of the lampshade 142 do not differ much, so that the flexible LED lamp 100 according to the present embodiment has better light emitting uniformity. Moreover, the distances between each of the LEDs 124 and the inner surface 142a of the lampshade 142 are very short, so that the flexible LED lamp 100 according to the present embodiment has high light-use efficiency.

Please refer to FIG. 4F. Next, the holder 110 and the lampshade 142 are arranged on the socket 144. According to the present embodiment, the holder 110 and the lampshade 142 may be arranged on the socket 144 by way of adhesive bonding, screwing, or similar methods. For example, the inner surface of the socket 144 according to the present embodiment has a first thread S1, an outer surface 110a of the holder 110 has a second thread S2, and the holder 110 is screwed into the socket through cooperation of the first thread Si and the second thread S2. According to FIG. 4F, the lampshade 142 and the socket 144 collectively define a closed accommodating space R in which the holder 110 and the flexible LED light bars 120 are housed.

[LED lamp]

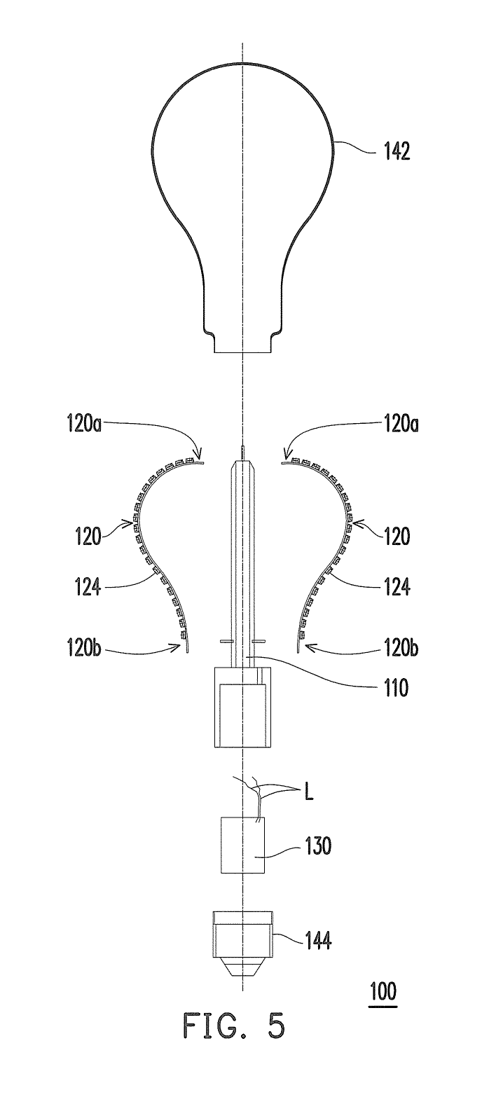

FIG. 4F is a schematic front diagram of an LED lamp according to an embodiment of the disclosure, and FIG. 5 is a schematic exploded diagram of an LED lamp according to an embodiment of the disclosure. Please refer to both FIGS. 4F and 5. The LED lamp 100 according to the present embodiment includes a lamp main body 140, a holder 110, and at least one flexible LED light bar 120. The lamp main body 140 includes the lampshade 142 and the socket 144, and the lamp main body 140 defines an accommodating space R. The holder 110 is disposed in the accommodating space R and fixed on the socket 144. The flexible LED light bar 120 is disposed in the accommodating space R, and each of two ends 120a and 120b of the flexible LED light bar is assembled on the holder 110. The flexible LED light bar 120 is bent outward to approach the inner surface 142a of the lampshade 142. According to the present embodiment, the flexible LED light bar 120 is assembled on the holder 110 to form a crescent shape. However, the disclosure is not limited to this configuration. According to another embodiment, the flexible LED light bar 120 may also have another shape not limited to that shown in FIG. 5.

It should be noted that in the LED lamp 100 according to the present embodiment, the closest distances between each of the LEDs 124 and the inner surface 142a of the lampshade 142 do not differ much, so that the flexible LED lamp 100 according to the present embodiment has greater light emitting uniformity. Moreover, the distances between each of the LEDs 124 and the inner surface 142a of the lampshade 142 are very short, so that the flexible LED lamp 100 according to the present embodiment has high light-use efficiency.

### Second Embodiment

### [Method for Fabricating LED Lamp]

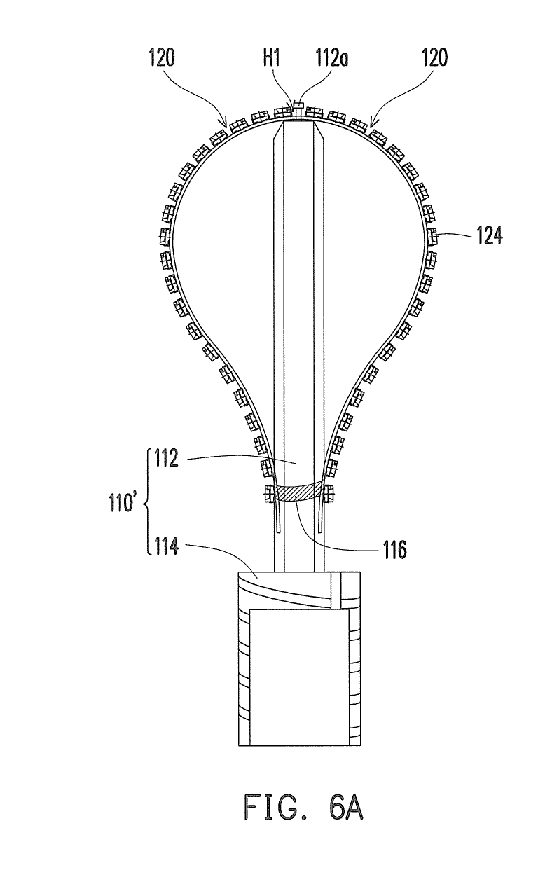

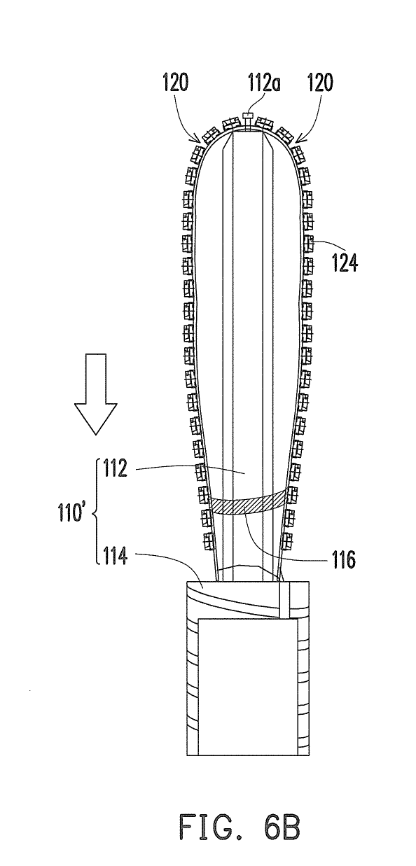

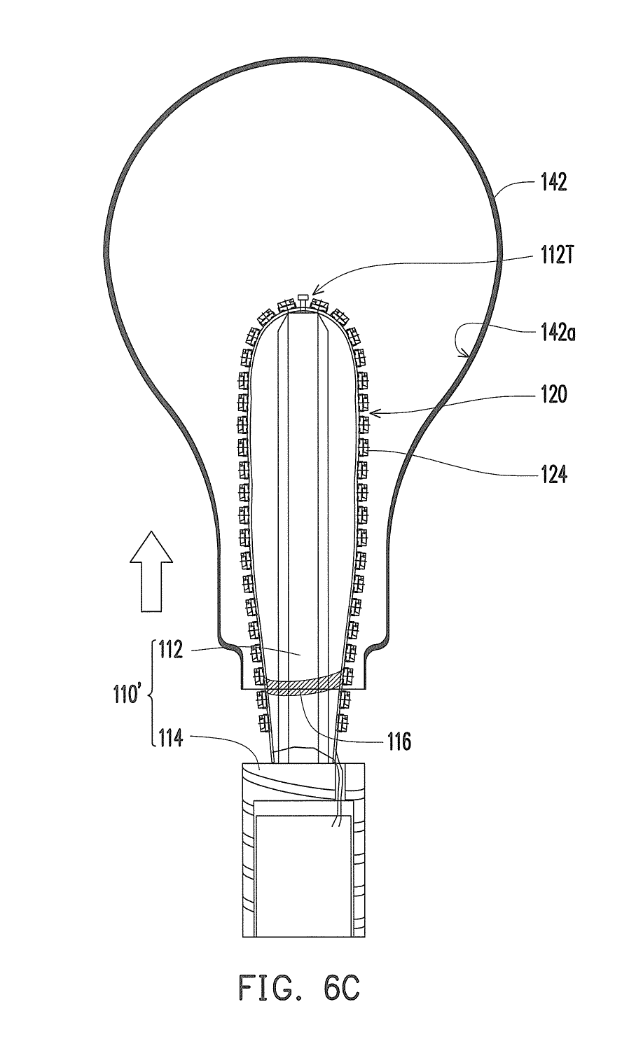

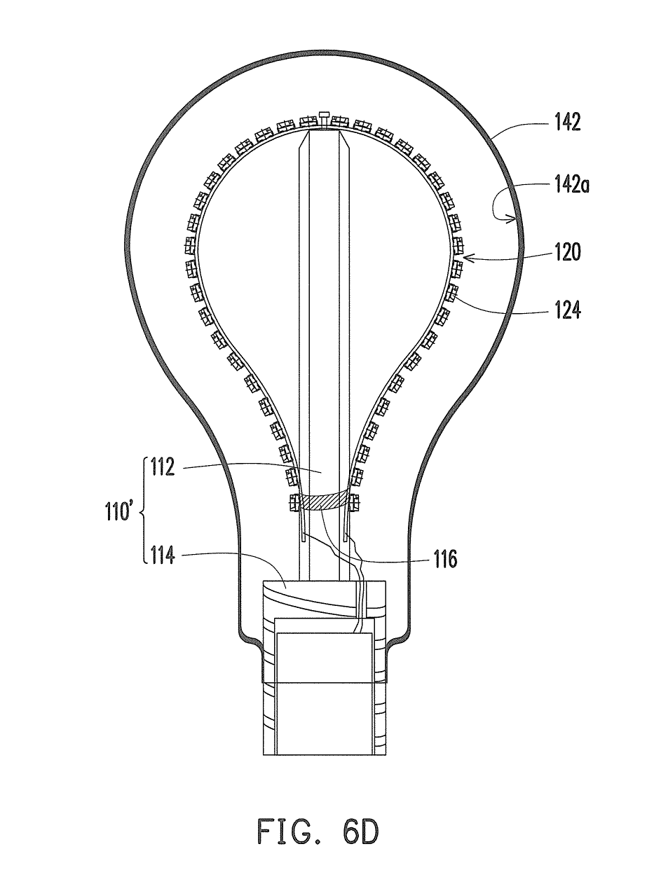

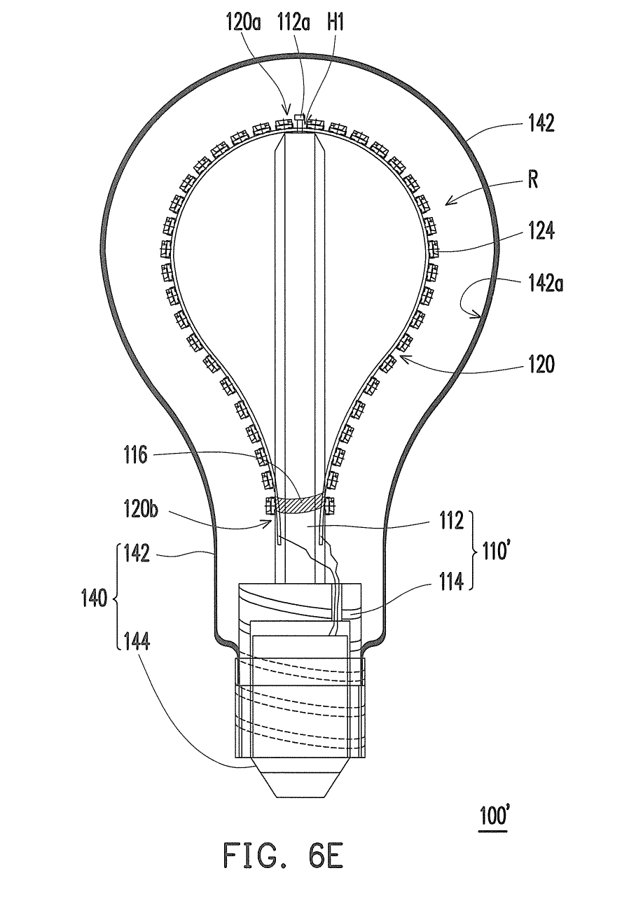

FIGS. 6A to 6E are schematic diagrams showing a fabrication process of the LED lamp according to the second embodiment of the disclosure. Please refer to FIG. 6A. First, a holder 110′ and at least one flexible LED light bar 120 are provided, and the flexible LED light bar 120 is assembled on the holder 110′. In detail, the holder 110′ according to the present embodiment includes a pillar 112, a base 114 connected to the pillar 112, and a confinement element 116. The pillar includes at least one upper fixing part 112a which passes through the first assembly hole H1 of the flexible LED light bar 120, and the confinement element 116 encircles the pillar 112 and binds the flexible LED light bar 120 on the pillar 112.

Please refer to FIG. 6B. The flexible LED light bar 120 is forced to approach the holder 110′. In detail, according to the present embodiment, by using the confinement element 116 to move the flexible LED light bar 120 to change the relative positions of the flexible LED light bar and the base 114, the flexible LED light bar 120 is forced to approach the pillar 112 of the holder 110′. The confinement element 116 according to the present embodiment is an elastic band, but is not limited to this configuration. According to another embodiment, the confinement element 116 may also be an element of another form that is able to move the flexible LED light bar 120. The form of the confinement element 116 is not limited to the confinement element 116 shown in FIG. 6B.

Please refer to FIGS. 6C, 6D, and 6E sequentially. Next, the flexible LED light bar 120 and the holder 110′ are inserted into the lampshade 142. After the flexible LED light bar 120 and the holder 110′ are inserted into the lampshade 142, the flexible LED light bar 120 is bent outward to approach the inner surface 142a of the lampshade 142. In detail, according to the present embodiment, a method for inserting the flexible LED light bar 120 and the holder 110′ into the lampshade 142 is, for example, using the confinement element 116 to move the flexible LED light bar 120 after the flexible LED light bar 120 and the holder 110′ are inserted into the lampshade 142, so that the flexible LED light bar 120 recovers to its original state (as shown in FIG. 6D). In other words, the confinement element 116 is pushed along the pillar 112 to the top 112T of the pillar 112 (as shown in FIG. 6C), so that the flexible LED light bar 120 is moved and the flexible LED light bar 120 recovers to its original state (as shown in FIG. 6D). Last, the holder 110′ and the lampshade 142 are assembled on the socket 114, and the LED lamp 100′ according to the present embodiment is complete. Similarly, in the LED lamp 100′ according to the present embodiment, the closest distances between each of the LEDs 124 and the inner surface 142a of the lampshade 142 do not differ much, so that the flexible LED lamp 100′ according to the present embodiment has greater light emitting uniformity. Moreover, the distances between each of the LEDs 124 and the inner surface 142a of the lampshade 142 are very short, so that the flexible LED lamp 100′ according to the present embodiment has high light-use efficiency.

[LED lamp]

FIG. 6E is a schematic diagram of an LED lamp according to the second embodiment of the disclosure. An LED lamp 100′ according to the present embodiment is similar to the LED lamp 100 according to the first embodiment A difference in between is that the holder 110′ according to the present embodiment is slightly different from the holder 110 according to the first embodiment. Only differences in between are described in the following, and similarities are not repeatedly described.

The LED lamp 100′ according to the present embodiment includes the lamp main body 140, the holder 110′, and at least one flexible LED light bar 120. The lamp main body 140 includes the lampshade 142 and the socket 144, and the lamp main body 140 defines an accommodating space R. The holder 110 is disposed in the accommodating space R and fixed on the socket 144. The flexible LED light bar 120 is disposed in the accommodating space R, and each of the two ends 120a and 120b of the flexible LED light bar is assembled on the holder 110. The flexible LED light bar 120 is bent outward to approach the inner surface 142a of the lampshade 142. A difference from the LED lamp 100 according to the first embodiment is that the holder 110′ according to the present embodiment includes the pillar 112, the base 114 connected to the pillar 112, and the confinement element 116. The pillar includes at least one upper fixing part 112a which passes through the first assembly hole H1 of the flexible LED light bar 120, and the confinement element 116 encircles the pillar 112 and binds the flexible LED light bar 120 on the pillar 112. In the LED lamp 100′ according to the present embodiment, the closest distances between each of the LEDs 124 and the inner surface 142a of the lampshade 142 do not differ much, so that the flexible LED lamp 100′ according to the present embodiment has greater light emitting uniformity. Moreover, the distances between each of the LEDs 124 and the inner surface 142a of the lampshade 142 are very short, so that the flexible LED lamp 100′ according to the present embodiment has high light-use efficiency.

### Third Embodiment

### [Method for Fabricating LED Lamp]

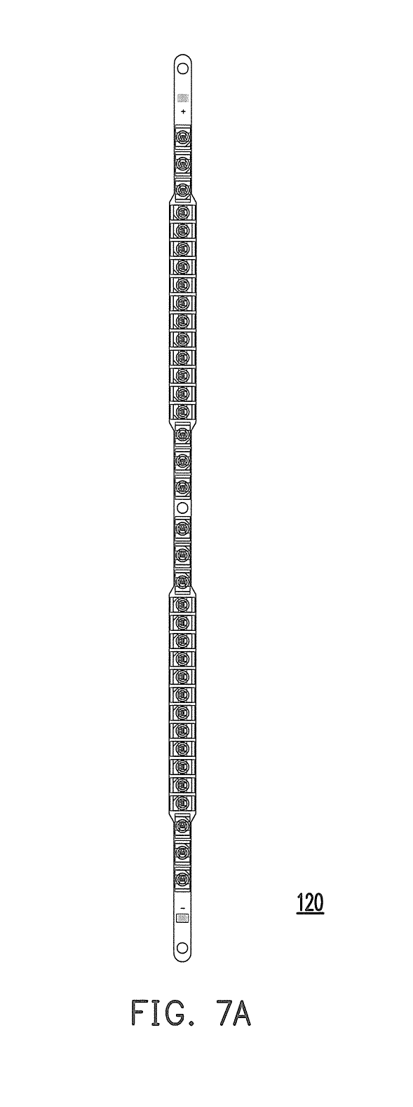

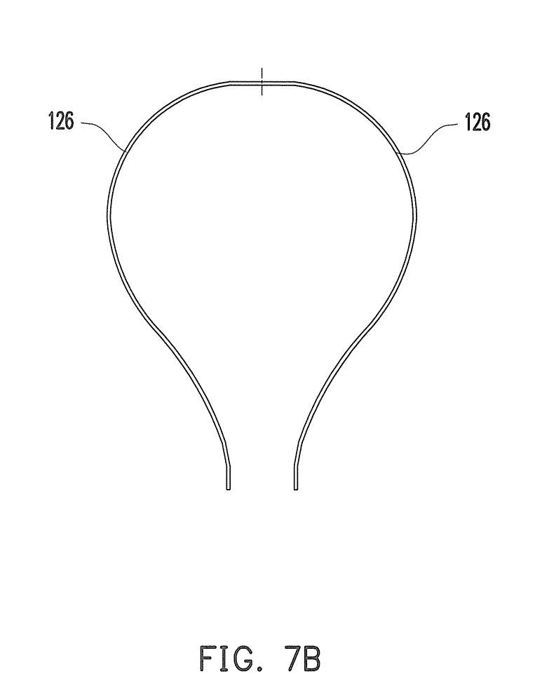

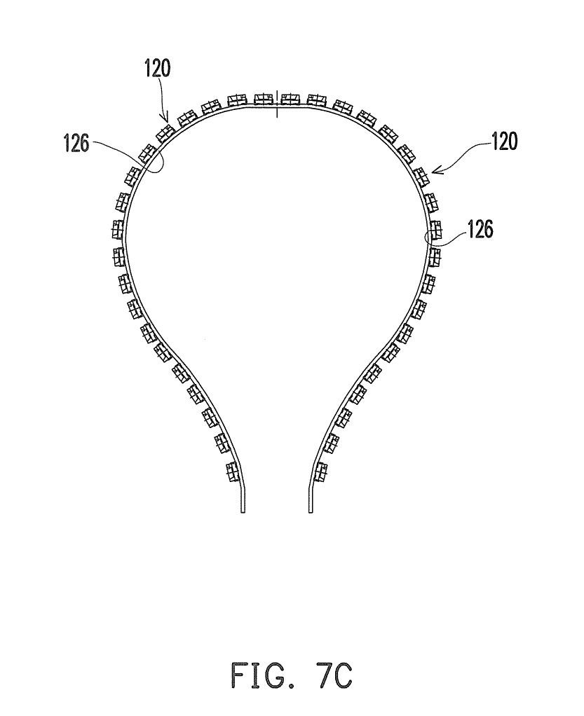

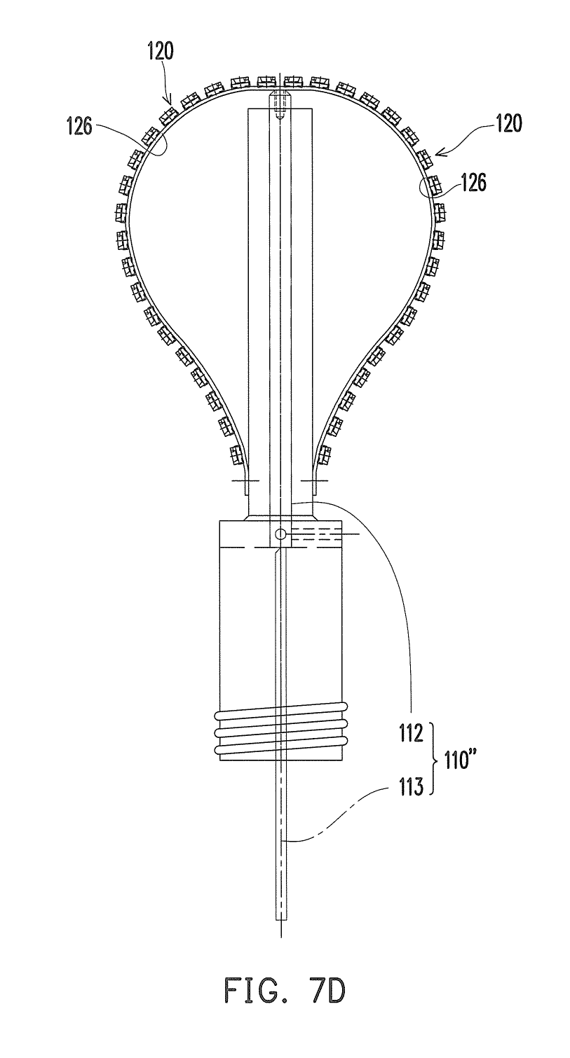

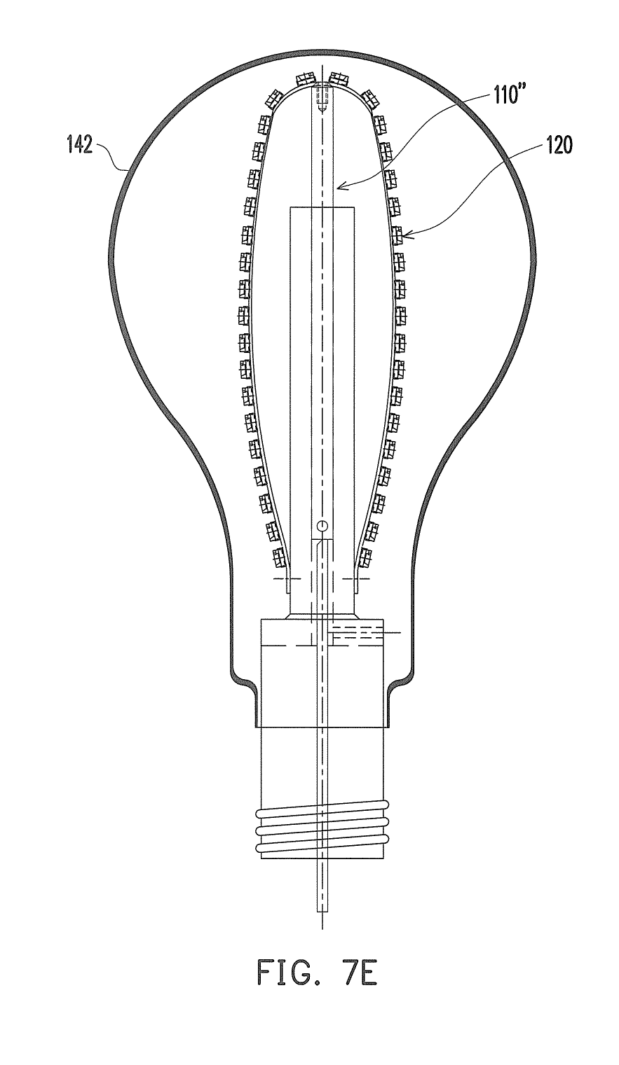

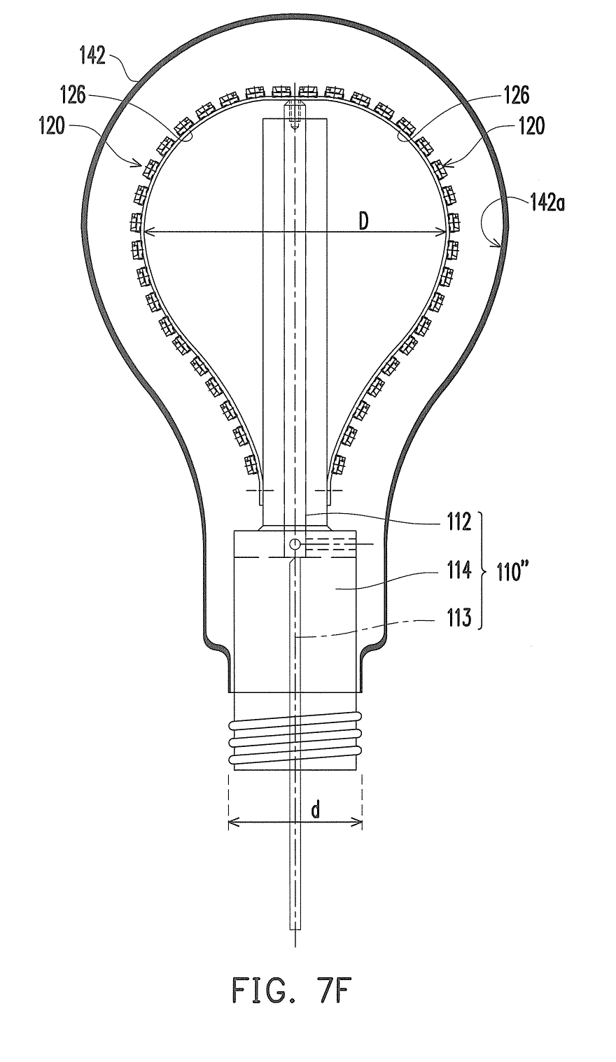

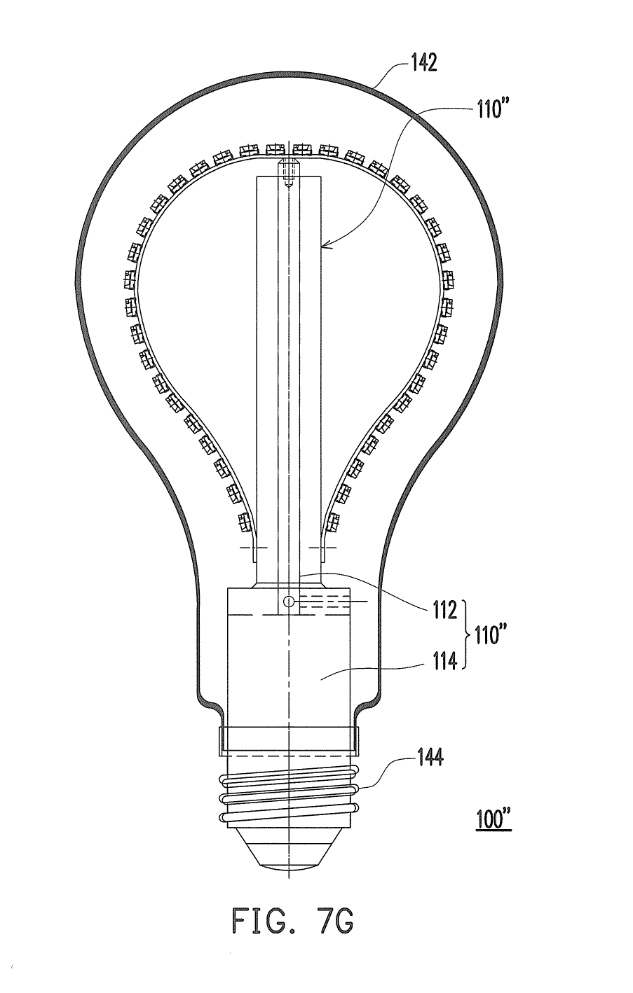

FIGS. 7A to 7G are schematic diagrams showing a fabrication process of an LED lamp according to the third embodiment of the disclosure. Please refer to FIGS. 7A, 7B, and 7C. At least one flexible LED light bar 120 and an elastic strip 126 are provided. Next, the flexible LED light bar 120 is fixed on the elastic strip 126. The elastic strip 126 according to the present embodiment has greater elasticity, so that the flexible LED light bar 120 fixed on the elastic strip 126 is stretched outward.

Please refer to FIG. 7D. The elastic strip 126 and the flexible LED light bar 120 fixed thereon are assembled on a holder 110″. The holder 110″ according to the present embodiment is similar to the holder 110 according to the first embodiment. A difference in between is that the holder 110″ according to the present embodiment has an auxiliary assembly part 113 connected to the pillar 112. It should be noted that the pillar 112 and the auxiliary assembly part 113 can be formed integrally. In other words, the pillar 112 and the auxiliary assembly part 113 can be considered one component of the LED lamp 100″.

Please refer to FIGS. 7E and 7F sequentially. First, the auxiliary assembly part 113 is pushed upwardly such that the elastic strip 126 having the flexible LED light bar 120 fixed thereon is forced to approach the holder 110″ (shown in FIG. 7E), and then the auxiliary assembly part 113 of the holder 110″ is used to insert the flexible LED light bar 120 and the holder 110″ into the lampshade 142. After the elastic strip 126, the flexible LED light bar 120 and the holder 110″ are inserted into the lampshade 142, the flexible LED light bar 120 and the holder 110″ are moved to designate positions by pushing the auxiliary assembly part 113 of the holder 110″ downwardly. At the same time, the flexible LED light bar 120 is bent outward by the elasticity of the elastic strip 126 to approach the inner surface 142a (shown in FIG. 7F) of the lampshade 142. According to the present embodiment, after the flexible LED light bar 120 is bent outward to approach the inner surface 142a of the lampshade 142, a maximum distance D between any two expanded flexible LED light bars 120 is 1 to 3 times a minimum opening diameter d of the lampshade. After the flexible LED light bar 120 is bent outward to approach the inner surface 142a of the lampshade 142,the holder 110″ is fastened on the base 114.

Please refer to FIG. 7G. Next, the auxiliary assembly part 113 of the holder 110″ is removed (by disjunction, for example) or bent toward the interior of the pillar 112, and the holder 110″ and the lampshade 142 are arranged on the socket 144. Hence, the LED lamp 100″ according to the present embodiment is complete. The LED lamp 100″ according to the present embodiment has the same effects and advantages as the LED lamp 100 according to the first embodiment. These effects and advantages are hence not repeatedly described.

In summary, in the method for fabricating the LED lamp according to the disclosure, by first assembling the flexible LED light bar on the holder and then inserting the flexible LED light bar and the holder into the lampshade, the shortest distances between each of the LEDs and the inner surface of the lampshade do not differ much, and the flexible LED lamp according to the disclosure has better light emitting unifoimity. Moreover, the distances between each of the LEDs and the inner surface of the lampshade are very short, so that the flexible LED lamp according to the disclosure has high light-use efficiency.

It will be apparent to those skilled in the art that various modifications and variations can be made to the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for fabricating a light emitting diode (LED) lamp, comprising:
providing a holder;
providing at least one flexible LED light bar, and assembling the LED light bar on the holder;
forcing the flexible LED light bar to approach the holder, and inserting the flexible LED light bar and the holder into the lampshade, wherein the flexible LED light bar is bent outward to approach an inner surface of the lampshade after the flexible LED light bar and the holder are inserted into the lampshade; and
assembling the holder and the lampshade on a socket.

2. The method for fabricating the LED lamp as claimed in claim 1, wherein the holder comprises:
a pillar, comprising at least one upper fixing part and at least one lower fixing part; and
a base, connected to the pillar, wherein the upper fixing part of the pillar and the lower fixing part of the pillar respectively pass through a first assembly hole and a second assembly hole of the flexible LED light bar, so that the flexible LED light bar is assembled on the holder.

3. The method for fabricating the LED lamp as claimed in claim 2, wherein a method for inserting the flexible LED light bar and the holder into the lampshade comprises:
pushing the flexible LED light bar and the holder into the lampshade, the flexible LED light bar is pressured by the lampshade to approach the inner surface of the lampshade during a process of pushing the flexible LED light bar into the lampshade, the flexible LED light bar is no longer pressured by the lampshade and recovers to an original state after the flexible LED light bar is completely pushed into the lampshade.

4. The method for fabricating the LED lamp as claimed in claim 2, wherein the upper fixing part of the pillar is located at a top of the pillar, and the lower fixing part is located at a sidewall of the pillar.

5. The method for fabricating the LED lamp as claimed in claim 4, wherein an angle θ is included between an extension direction of the upper fixing part of the pillar and an extension direction of the lower fixing part of the pillar, wherein 90°≦θ≦180°.

6. The method for fabricating the LED lamp as claimed in claim 2, wherein a shape of the first assembly hole and the second assembly hole of the flexible LED light bar comprises: a circle, a rectangle, or a shape with a necking portion.

7. The method for fabricating the LED lamp as claimed in claim 1, wherein the holder comprises:
a pillar, comprising at least one upper fixing part which passes through a first assembly hole of the flexible LED light bar;
a base, connected to the pillar; and
a confinement element, encircling the pillar and binding the flexible LED light bar on the pillar.

8. The method for fabricating the LED lamp as claimed in claim 7, wherein a method for forcing the flexible LED light bar to approach the holder comprises:
changing relative positions of the flexible LED light bar and the base by the confinement element, so that the flexible LED light bar is moved and forced to approach the pillar of the holder.

9. The method for fabricating the LED lamp as claimed in claim 8, wherein a method for inserting the flexible LED light bar and the holder into a lampshade comprises:
moving the flexible LED light bar by the confinement element to make the flexible LED light bar recover to an original state after the flexible LED light bar and the holder are inserted into the lampshade.

10. The method for fabricating the LED lamp as claimed in claim 1, further comprising a driving current control circuit, disposed in the holder and electrically connected to the flexible LED light bar.

11. The method for fabricating the LED lamp as claimed in claim 1, wherein the holder comprises a through hole which is passed through by a wire, and the wire is electrically connected to the flexible LED light bar and the driving current control circuit.

12. The method for fabricating the LED lamp as claimed in claim 1, wherein the inner surface of the socket has a first thread, an outer surface of the holder has a second thread, and the holder is screwed into the socket through cooperation of the first thread and the second thread.

13. The method for fabricating the LED lamp as claimed in claim 1, wherein after the flexible LED light bar is bent outward to approach the inner surface of the lampshade, a maximum distance between any two flexible LED light bars is 1 to 3 times a minimum opening diameter of the lampshade.

14. An LED lamp, comprising:
a lamp main body, comprising a socket and a lampshade, and the lamp main body defines an accommodating space;
a holder, disposed in the accommodating space and fixed on the socket;
at least one flexible LED light bar, disposed in the accommodating space, each of two ends and of the flexible LED light bar is assembled on the holder, and the flexible LED light bar is bent outward to approach an inner surface of the lampshade.

15. The LED lamp as claimed in claim 14, wherein the holder comprises:
a pillar, comprising at least one upper fixing part and at least one lower fixing part; and
a base, connected to the pillar, wherein the upper fixing part of the pillar and the lower fixing part of the pillar respectively pass through a first assembly hole and a second assembly hole of the flexible LED light bar, so that the flexible LED light bar is assembled on the holder.

16. The LED lamp as claimed in claim 15, wherein the upper fixing part of the pillar is located at a top of the pillar, and the lower fixing part is located at a sidewall of the pillar.

17. The LED lamp as claimed in claim 16, wherein an angle θ is included between an extension direction of the upper fixing part of the pillar and an extension direction of the lower fixing part of the pillar, wherein 90°≦θ≦180°.

18. The LED lamp as claimed in claim 15, wherein a shape of the first assembly hole and the second assembly hole of the flexible LED light bar comprises: a circle, a rectangle, or a shape with a necking portion.

19. The LED lamp as claimed in claim 14, wherein the holder comprises:
a pillar, comprising at least one upper fixing part which passes through a first assembly hole of the flexible LED light bar;
a base, connected to the pillar; and
a confinement element, encircling the pillar and binding the flexible LED light bar on the pillar.

20. The LED lamp as claimed in claim 14, further comprising a driving current control circuit, disposed in the holder and electrically connected to the flexible LED light bar.

21. The LED lamp as claimed in claim 14, further comprising a wire, wherein the holder comprises a through hole which is passed through by the wire, and the wire is electrically connected to the flexible LED light bar and the driving current control circuit.

22. The LED lamp as claimed in claim 14, wherein the inner surface of the socket has a first thread, an outer surface of the holder has a second thread, and the holder is screwed into the socket through cooperation of the first thread and the second thread.

23. The LED lamp as claimed in claim 14, wherein a maximum distance between any two flexible LED light bars is 1 to 3 times a minimum opening diameter of the lampshade.
